(19) United States
(12) Patent Application Publication
(10) Pub. No.: US 2025/0056198 A1
(43) Pub. Date: Feb. 13, 2025

(54) EMERGENCY COMMUNICATIONS SYSTEMS AND METHODS

(71) Applicant: Michael John Maloney Reynolds, Moses Lake, WA (US)

(72) Inventor: Michael John Maloney Reynolds, Moses Lake, WA (US)

(21) Appl. No.: 18/758,018

(22) Filed: Jun. 28, 2024

Related U.S. Application Data
(60) Provisional application No. 63/518,422, filed on Aug. 9, 2023.

(51) Int. Cl. H04W 4/90; H04W 76/14; H04W 88/08

(52) U.S. Cl. CPC H04W 4/90; H04W 76/14; H04W 88/08

(57) ABSTRACT

A system for emergency communications includes a host unit and a command unit. The host unit includes a host access point. The command unit includes a command access point. The host access point is configured to generate an area network. The host access point and the command access point establish a first peer-to-peer wireless connection over the area network.

### PRIORITY

This application claims priority from U.S. Ser. No. 63/518,422 filed on Aug. 9, 2023.

### FIELD

The present disclosure relates generally to communications systems and, more particularly, to modular, deployable, wireless systems for establishing communications in emergency situations.

### BACKGROUND

There are various situations in which communication and/or observation are critical but challenging or even dangerous to those involved. As an example, in a hostage situation, a perpetrator may barricade an area. Tactical officers must be positioned close to the hostile area to monitor the situation. A negotiator and/or other officials must contact the perpetrator and communicate throughout the hostile event. Setting up an observation post and/or a communications center at a location proximate to the hostile area puts officers at risk. However, observation and communication are necessary for a successful negotiating process. Accordingly, those skilled in the art continue with research and development efforts in the field of communications in emergency situations.

### SUMMARY

Disclosed are examples of a system and a method for emergency communications. The following is a non-exhaustive list of examples, which may or may not be claimed, of the subject matter according to the present disclosure.

In an example, the disclosed system includes a host unit and a command unit. The host unit includes a host access point. The command unit includes a command access point. The host access point is configured to generate an area network. The host access point and the command access point establish a first peer-to-peer wireless connection over the area network.

In another example, the disclosed system includes a host unit, a command unit, and the deployable unit. The host unit includes a host access point configured to generate an area network and at least one of a speaker, microphone, and a camera in communication with the host access point. The command unit includes a command access point, a controlling device in communication with the command access point, and a headset in communication with the command access point. The deployable unit includes a deployable access point and at least one of an intercom and a handset in communication with the deployable access point. The host access point and the command access point establish a first peer-to-peer wireless connection over the area network. The host access point and the deployable access point establish a second peer-to-peer wireless connection over the area network. Each one of the host access point, the command access point, and the deployable access point has a unique static IP address.

In an example, the disclosed method includes steps of: (1) generating an area network with a host access point; (2) establishing a first peer-to-peer wireless connection between the host access point and a command access point over the area network; (3) establishing a second peer-to-peer wireless connection between the host access point and a deployable access point over the area network; (4) wirelessly transmitting a data stream between the host access point and the command access point; (5) wirelessly transmitting the data stream between the host access point and the deployable access point; and (6) wirelessly transmitting the data stream between the command access point and the deployable access point via the host access point. A host static IP address, a command static IP address, and a deployable static IP address are different.

Other examples of the system and method will become apparent from the following detailed description, the accompanying drawings, and the appended claims.

### BRIEF DESCRIPTION OF THE DRAWINGS

FIGS. 1A and 1B, collectively FIG. 1, are a schematic block diagram of an example of a system for emergency communications;

FIG. 2 is a flow diagram of an example of a method for emergency communications;

FIG. 3 is a schematic block diagram of an example of a host unit of the system;

FIG. 4 is a schematic block diagram of an example of a command unit of the system;

FIG. 5 is a schematic block diagram of an example of a deployable unit of the system;

FIG. 6 is a schematic illustration of an example of the system;

FIG. 7 is a schematic illustration of an example of the system;

FIG. 8 is a schematic illustration of an example of the system;

FIG. 9 is a schematic illustration of an example of the system;

FIG. 10 is a schematic illustration of an example of the system; and

FIG. 11 is a schematic illustration of an example of a user interface of the command unit.

### DETAILED DESCRIPTION

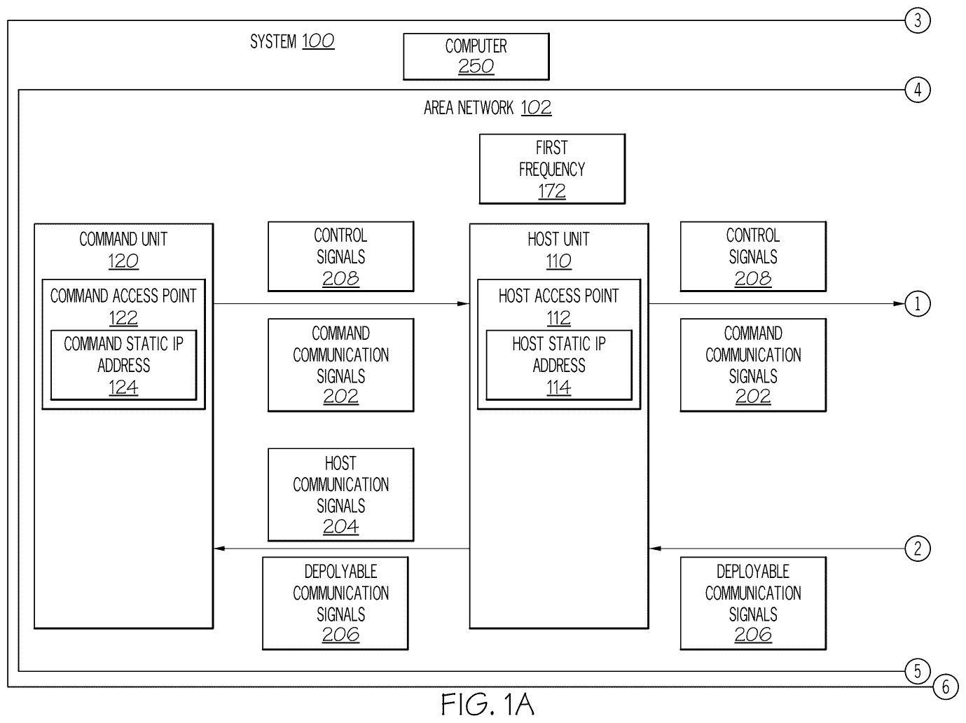

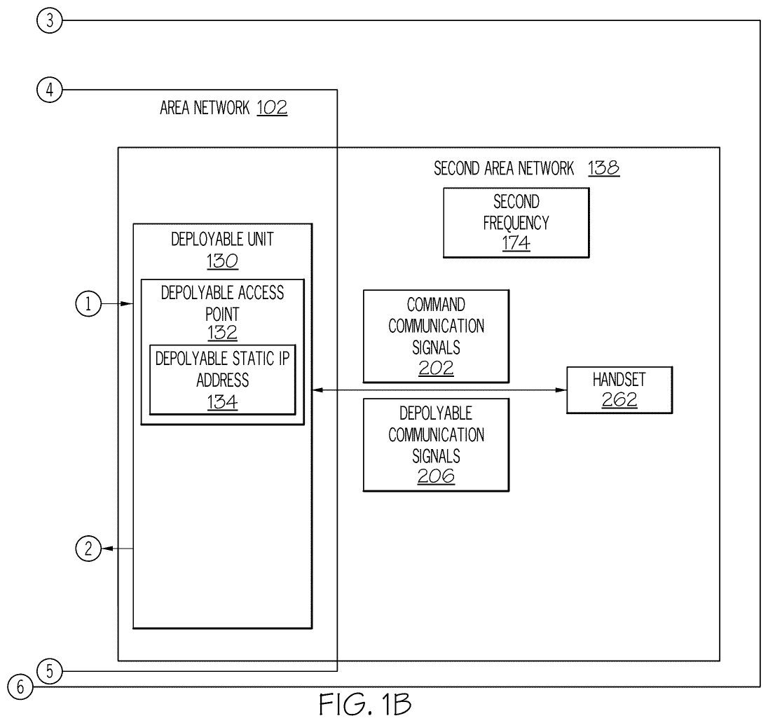

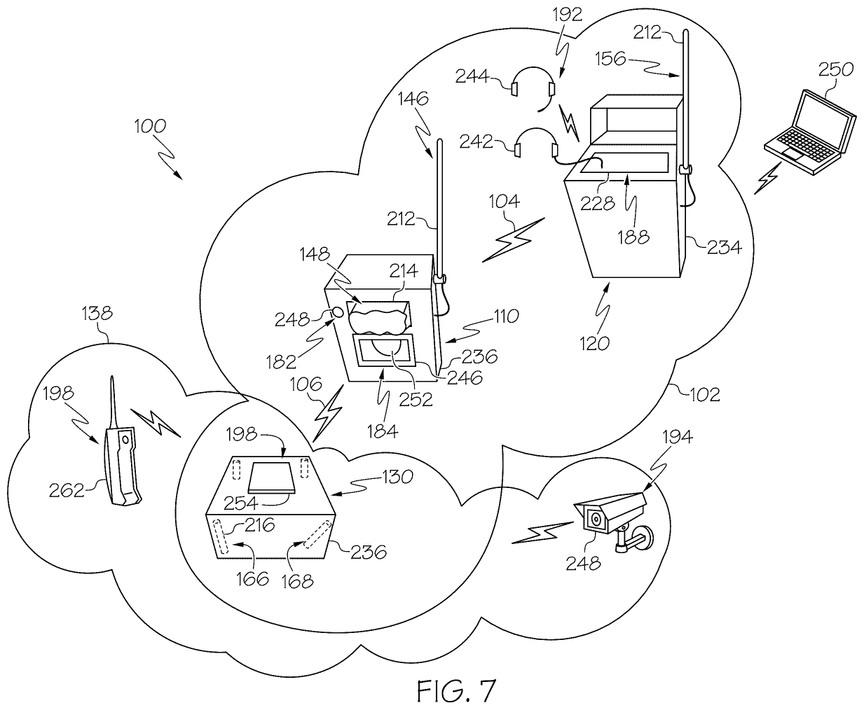

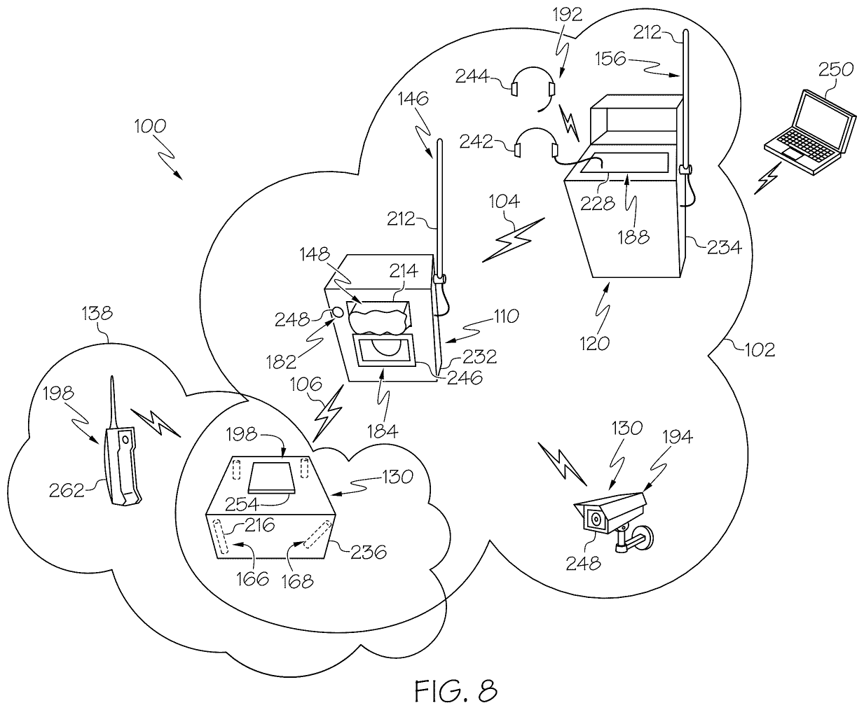

Referring generally to FIGS. 1-11, by way of examples, the present disclosure is directed to a system 100 and a method 1000 for wirelessly communicating in any one of a variety of nontraditional, exigent, critical, or emergency situations.

Various illustrative examples of the system 100 and method 1000 disclosed herein are particularly directed to providing a means for safe remote communications during a hostage negotiation. The present disclosure recognizes that hostage situations place lives are at risk, and the success of negotiations often hinges on establishing clear communication and making assessments based on accurate, real-time information. However, traditional negotiation methods typically require activity near a hostile area and at least some physical interaction with the perpetrator, which can put the officers and negotiators involved in immediate danger and potentially escalate the situation.

Examples of the system 100 and method 1000 disclosed herein address the issues associated with traditional negotiation methods by providing a rugged, modular, deployable, wireless means of communication in situations where traditional modes of communication are not feasible, not safe, or otherwise not available. Examples of the system 100 and method 1000 enable generation of an ad hoc wireless network that facilitates wireless transmission of voice, video, and other data without requiring infrastructure, such as power or a data service provider.

However, the system 100 and method 1000 are not intended to be limited to hostage situations or other hostile or high-risk situations. Various examples of the system 100 and method 1000 provide a means for communications during any situation where traditional communication infrastructure is unavailable, such as during search and rescue operations, disaster relief, mental health interventions, border control and immigration, remote communication training, medical situations, educational settings, clandestine operations, or any other application that may be useful.

Referring now to FIGS. 1A, 1B and 3-11, the following are examples of the system 100, according to the present disclosure. The system 100 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring to FIGS. 1A and 1B, collectively referred to herein as FIG. 1, as will be described in more detail herein, in various examples, the system 100 includes a number of components, including one or more of a host unit 110, a host access point 112, a command unit 120, a command access point 122, a deployable unit 130, a deployable access point 132, a host observing device 182, a host broadcasting device 184, a host communicating device 186, a command communicating device 192, a deployable observing device 194, a deployable broadcasting device 196, and a deployable communicating device 198.

Referring to FIGS. 1 and 3-11, in one or more examples, the system 100 includes the host unit 110. The host unit 110 includes the host access point 112. The host access point 112 is configured to generate an area network 102. In other words, the host unit 110 (e.g., the host access point 112) serves as ad hoc network host. The area network 102 enables wireless connectivity, communication, and control between various components of the system 100.

In various examples, the host unit 110 is portable or mobile and can be placed at any suitable or desired location for a particular communications application. In the negotiations example, the host unit 110 can be placed relative to the hostile location. As an example, the host unit 110 can be placed on the ground or street across from the hostile location. As such, in certain applications, the host unit 110 may be referred to as a “street” unit or “ground” unit. In some examples, such as communication with and control of the deployable unit 130, the host unit 110 can be placed up to one (1) mile away from the hostile location. In some examples, such as for direct observation and/or communication, line of sight between the host unit 110 and the hostile location may be desirable or necessary.

In one or more examples, the system 100 includes the command unit 120. The command unit 120 includes the command access point 122. The command access point 122 is configured to communicate with the host access point 112 over the area network 102. As an example, the host access point 112 and the command access point 122 establish and communicate via a first peer-to-peer wireless connection 104 over the area network 102.

In various examples, the command unit 120 is portable or mobile and can be placed at any suitable or desirable location for a particular communications application. In the negotiations example, the command unit 120 can be placed at a temporary command and control center or other facility designated for operational purposes and/or use by negotiators or other officials. As such, in certain applications, the command unit 120 may be referred to as a “negotiator” unit. In some examples, such as communication with and control of the host unit 110 and/or the deployable unit 130, the command unit 120 can be placed up to one (1) mile away from the host unit 110.

In one or more examples, the system 100 includes the deployable unit 130. The deployable unit 130 includes the deployable access point 132. The deployable access point 132 is configured to communicate with the host access point 112 over the area network 102. As an example, the host access point 112 and the deployable access point 132 establish and communicate via a second peer-to-peer wireless connection 106 over the area network 102. In these examples, the host unit 110 connects the command unit 120 and the deployable unit 130. For example, the command access point 122 and the deployable access point 132 communicate with and/or transfer data between each other via or through the host access point 112.

In various examples, the deployable unit 130 is portable or mobile and can be placed at any suitable or desirable location for a particular communications application. In the negotiations example, the deployable unit 130 can be “thrown” or otherwise deployed (e.g., positioned, stationed, situated, delivered, etc.) at the hostile location for interaction with a hostile party or surrounding area. As such, in certain applications, the deployable unit 130 may be referred to as a “throw” unit or an “action” unit. In some examples, such as communication with the command unit 120, the deployable unit 130 can be placed up to one (1) mile away from the host unit 110.

In one or more examples, each one of the host access point 112, the command access point 122, and the deployable access point 132 includes or takes the form of a suitable wireless network access point or device that creates (e.g., is configured to create) a wireless local area network, projects (e.g., configured to project) a Wi-Fi signal to a designated area, and/or enables (e.g., configured to enable) wireless-capable devices to connect to the network (e.g., area network 102). As an example, at least one, or each one, of the host access point 112, the command access point 122, and the deployable access point 132 includes functional components common to commercially available network access points, such as, but not limited to, one or more central processing units (CPU), one or more radio transceivers, one or more antennas, and operational software.

Referring to FIG. 1, in one or more examples, each one of the host access point 112, the command access point 122, and the deployable access point 132 has or is programmed with a dedicated static internet protocol (IP) address. As examples, the host access point 112 includes a host static IP address 114 (e.g., first static IP address). The command access point 122 includes a command static IP address 124 (e.g., a second static IP address). The deployable access point 132 includes a deployable static IP address 134 (e.g., a third static IP address). The host static IP address 114, the command static IP address 124, and the deployable static IP address 134 are different.

In these examples, utilizing pre-set or pre-configured connections using static IP addresses enables each unit (e.g., access point) to be programmed to automatically connect and communicate with another one of the units (e.g., access point) according to the pre-set and known static IP address. As an example, communication between units (e.g., access points) can be initiated by the press of a button, which automatically initiates a pre-designated “dialing sequence” that connects to the pre-set static IP address corresponding to one of the units (e.g., access points) and associated with that button. Additionally, utilizing pre-set or pre-configured connections using static IP addresses improves manufacturability and enables components of the system 100 and/or individually units to be replaced, interchanged, and/or upgraded as long as the component has the uniform, designated static IP address.

In one or more examples, the host unit 110 (e.g., host access point 112), the command unit 120 (e.g., command access point 122), and the deployable unit 130 (e.g., deployable access point 132) wireless communicate with each other over the area network 102 using a first frequency 172. The first frequency 172 can by any suitable frequency depending on the application of the system 100, the location of use, government regulations, and the like. In one particular example, the first frequency 172 is 4.9 GHZ.

Referring to FIGS. 1, 3 and 6-10, in one or more examples, the host unit 110, such as the host access point 112, includes at least one host antenna 116. In some examples, the host unit 110 (e.g., host access point 112) includes a plurality of host antennas 116.

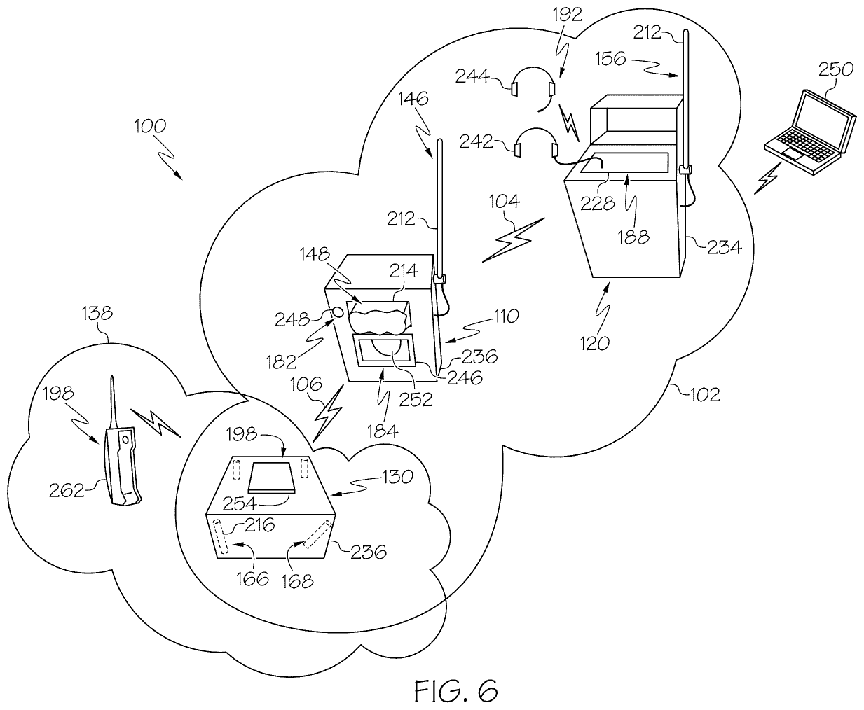

In one or more examples, the host antenna 116 includes or takes the form of at least one omnidirectional antenna 176, such as a host omnidirectional antenna 146. In one or more examples, the host omnidirectional antenna 146 includes or takes the form of a 24 decibel (dB) omnidirectional stick antenna 212 (e.g., FIGS. 6-10). In these examples, the host omnidirectional antenna 146 facilitates or enables wireless communication with the command unit 120 (e.g., command access point 122) and/or the deployable unit 130 (e.g., deployable access point 132). The host omnidirectional antenna 146 enables movement of the host unit 110 relative to the command unit 120 and/or the deployable unit 130. The host omnidirectional antenna 146 enables the command unit 120 to be separated from the host unit 110 and/or a potentially hostile or dangerous location by a safe distance.

In one or more examples, the host antenna 116 includes or takes the form of at least one directional antenna 178, such as a host directional antenna 148. In one or more examples, the host directional antenna 148 includes or takes the form of a directional pancake antenna 214 (e.g., FIGS. 6-9). In these examples, the host directional antenna 148 facilitates or enables wireless communication with the deployable unit 130 (e.g., deployable access point 132). In these examples, the host directional antenna 148 is used to boost or enhance the power, radiation, signal, and/or distance of the host unit 110 (e.g., host access point 112). The host directional antenna 148 enables communication with the deployable unit 130 (e.g., deployable access point 132) in situations where a signal from the host omnidirectional antenna 146 lacks sufficient power or range to reach the deployable unit 130 (e.g., deployable access point 132).

Referring to FIGS. 1, 4 and 6-10, in one or more examples, the command unit 120, such as the command access point 122, includes at least one command antenna 126. In some examples, the command unit 120 (e.g., command access point 122) includes a plurality of host antennas 116.

In one or more examples, the command antenna 126 includes or takes the form of at least one omnidirectional antenna 176, such as a command omnidirectional antenna 156. In one or more examples, the command omnidirectional antenna 156 includes or takes the form of a 24 decibel (dB) omnidirectional stick antenna 212 (e.g., FIGS. 6-10). In these examples, the command omnidirectional antenna 156 facilitates or enables wireless communication with the host unit 110 (e.g., host access point 112). The command omnidirectional antenna 156 enables movement of the command unit 120 relative to the host unit 110. The command omnidirectional antenna 156 enables the command unit 120 to be separated from the host unit 110 and/or a potentially hostile or dangerous location by a safe distance.

Referring to FIGS. 1 and 5-9, in one or more examples, the deployable unit 130, such as the deployable access point 132, includes at least one deployable antenna 136. In some examples, the deployable unit 130 (e.g., deployable access point 132) includes a plurality of deployable antennas 136.

In one or more examples, the deployable antenna 136 includes or takes the form of a plurality of directional antennas 178, such as a plurality (e.g., threc) deployable directional antennas 166. In one or more examples, each one of the deployable directional antennas 166 includes or takes the form of a directional sector antenna 216 (e.g., 6-8). In these examples, the deployable directional antennas 166 facilitate or enable wireless communication with the host unit 110 (e.g., host access point 112). The deployable directional antennas 166 (e.g., three sector antennas 216) enable the deployable unit 130 (e.g., deployable access point 132) to communicate with the host unit 110 (e.g., host access point 112) regardless of the spatial orientation or position of the host unit 110. These examples enable the deployable unit 130 to take the form of a “throw case” that can be thrown or otherwise hastily deployed in a hostile area without consideration of particular placement or orientation of the deployable unit 130. These examples also enable the deployable unit 130 to be moved, knocked over, etc., which is likely to occur in an uncontrolled or hostile environment.

In one or more examples, the deployable antenna 136 includes or takes the form of at least one omnidirectional antenna 176, such as a deployable omnidirectional antenna 168. In one or more examples, the deployable omnidirectional antenna 168 includes or takes the form of an omnidirectional stick antenna 212 (e.g., FIGS. 6-9). In one or more examples, the deployable omnidirectional antenna 168 facilitates or enables wireless communication between the deployable unit 130 (e.g., deployable access point 132) and the host unit 110 (e.g., host access point 112). In these examples, the deployable omnidirectional antenna 168 enables movement of the deployable unit 130 relative to the host unit 110. In one or more examples, the deployable omnidirectional antenna 168 facilitates or enables (e.g., is dedicated to) wireless communication between the deployable unit 130 (e.g., deployable access point 132) and another remotely situated functional component of the deployable unit 130 or the system 100, such as a deployable communicating device 198, a deployable observing device 194, and/or a deployable broadcasting device 196. In these examples, the deployable omnidirectional antenna 168 enables movement of the deployable communicating device 198, the deployable observing device 194, and/or the deployable broadcasting device 196 relative to the deployable access point 132.

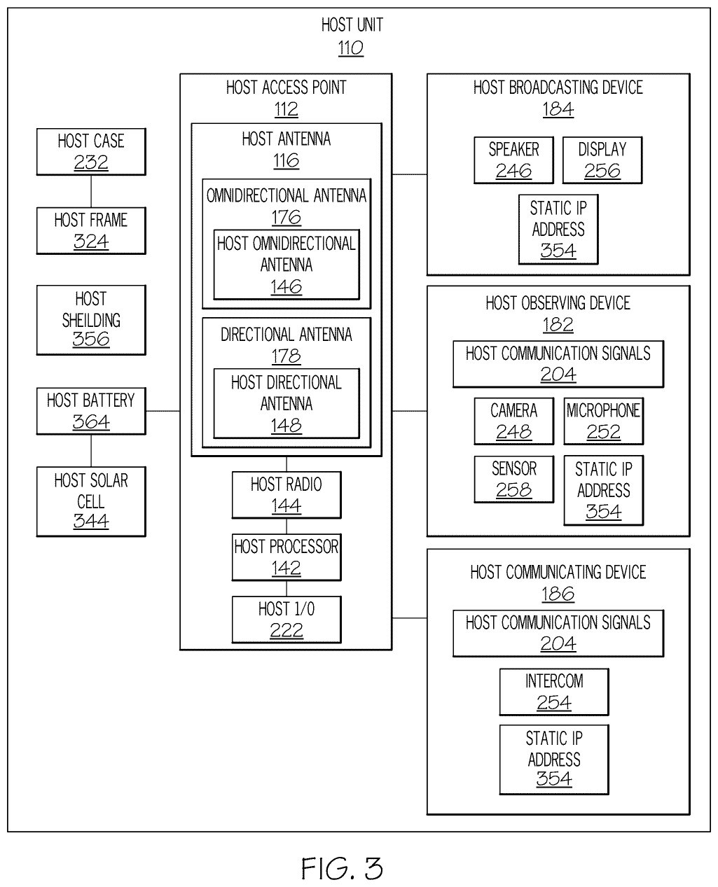

Referring to FIG. 3, in one or more examples, the host unit 110, such as the host access point 112, includes other functional components that enable generation of the area network 102 and/or wireless communication over the area network 102. As an example, the host unit 110, such as the host access point 112, includes at least one host radio 144. The host antenna 116 is coupled to the host radio 144. In one or more examples, the host radio 144 is a transceiver that is capable of transmitting and receiving radio signals. In one or more examples, the host access point 112 includes a plurality of (e.g., four) host radios 144. In these examples, each host radio 144 includes a dedicated transceiver. In one or more examples, the host access point 112 includes one host radio 144. In these examples, the host radio 144 can include one transceiver or a plurality (e.g., four) dedicated transceivers. In one or more examples, the host unit 110 includes a plurality of host antennas 116 and each host antenna 116 is coupled to one of the transceivers or host radios 144.

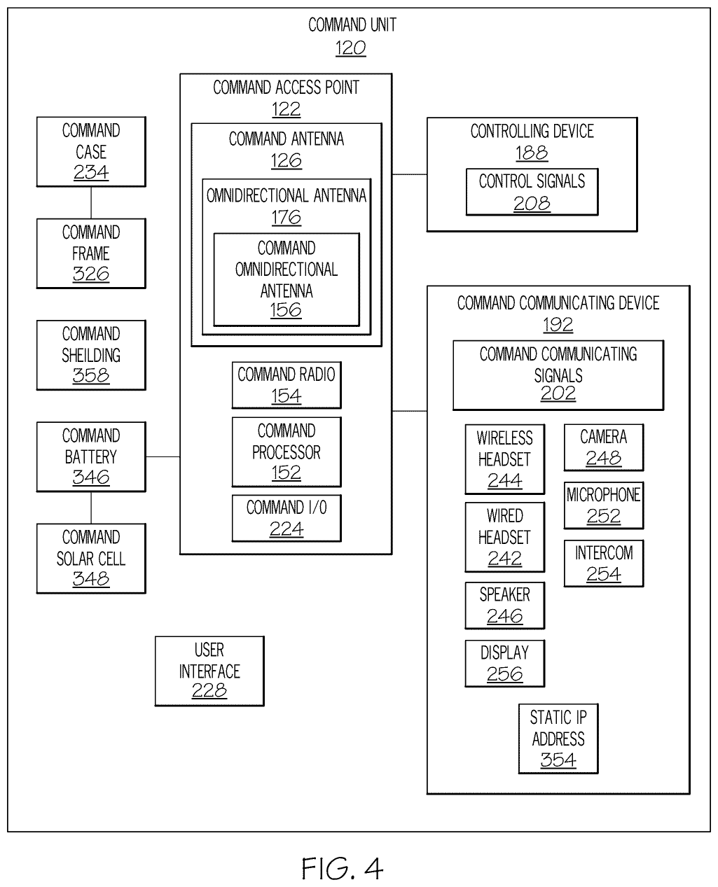

Referring FIG. 4, in one or more examples, the command unit 120, such as the command access point 122, includes other functional components that enable wireless communication over the area network 102. As an example, the command unit 120, such as the command access point 122, includes at least one command radio 154. The command antenna 126 is coupled to the command radio 154. In one or more examples, the command radio 154 is a transceiver that is capable of transmitting and receiving radio signals. In one or more examples, the command access point 122 includes a plurality of (e.g., four) command radios 154. In these examples, each command radio 154 includes a dedicated transceiver. In one or more examples, the command access point 122 includes one command radio 154. In these examples, the command radio 154 can include one transceiver or a plurality (e.g., four) dedicated transceivers. In one or more examples, the command unit 120 includes a plurality of command antennas 126 and each command antenna 126 is coupled to one of the transceivers or command radios 154.

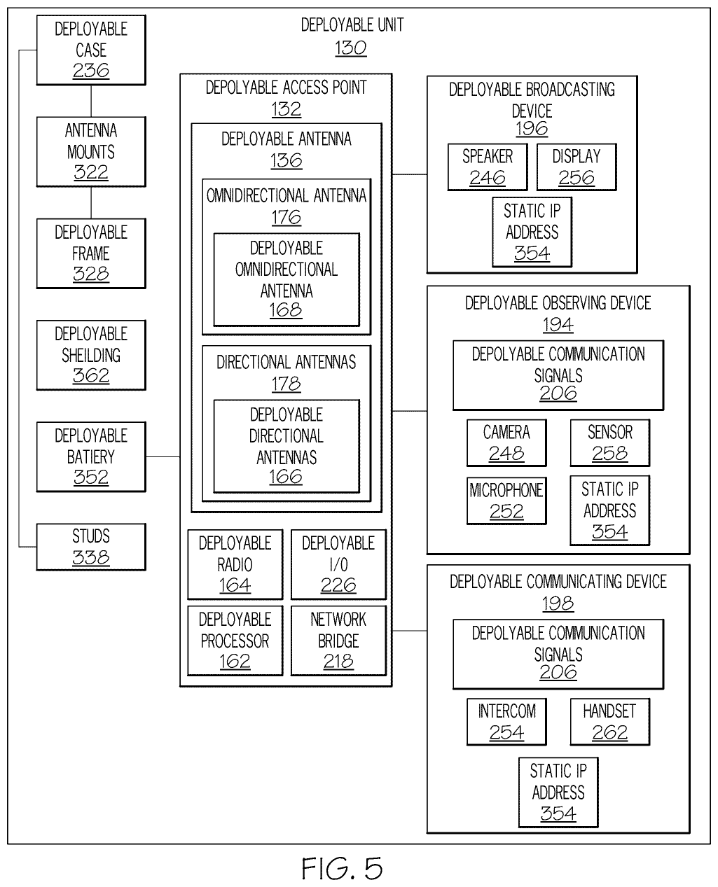

Referring to FIG. 5, in one or more examples, the deployable unit 130, such as the deployable access point 132, includes other functional components that enable wireless communication over the area network 102. As an example, the deployable unit 130, such as the deployable access point 132, includes at least one deployable radio 164. The deployable antenna 136 is coupled to the deployable radio 164. In one or more examples, the deployable radio 164 is a transceiver that is capable of transmitting and receiving radio signals. In one or more examples, the deployable access point 132 includes a plurality of (e.g., four) deployable radios 164. In these examples, each deployable radio 164 includes a dedicated transceiver. In one or more examples, the deployable access point 132 includes one deployable radio 164. In these examples, the deployable radio 164 can include one transceiver or a plurality (e.g., four) dedicated transceivers. In one or more examples, the deployable unit 130 includes a plurality of deployable antennas 136 and each deployable antenna 136 is coupled to one of the transceivers or deployable radios 164.

Referring to FIGS. 1 and 4, in one or more examples, the command unit 120 includes a controlling device 188 (e.g., controller). The controlling device 188 is coupled to and is in communication with the command access point 122. The controlling device 188 is configured to generate control signals 208. In one or more examples, the control signals 208 are transmitted to the host access point 112 and are used to initiate, terminate, or otherwise control one or more functions or components of the host unit 110. In one or more examples, the control signals 208 are transmitted to the deployable access point 132, via the host access point 112, and are used to initiate, terminate, or otherwise control one or more functions or components of the deployable unit 130.

In these examples, the controlling device 188 generates the control signals 208. The command access point 122 transmits the control signals 208 to the host access point 112. The host access point 112 transmits the control signals 208 to one or more components (e.g., host broadcasting devices 184, host observing devices 182, host communicating devices 186, etc.) of the host unit 110 to initiate, terminate, or otherwise control one or more functions of the host unit 110. In one or more examples, the host access point 112 transmits or relays the control signals 208 to the deployable access point 132. The deployable access point 132 transmits the control signals 208 to one or more components (e.g., deployable broadcasting devices 196, deployable observing devices 194, deployable communicating devices 198, etc.) of the deployable unit 130 to initiate, terminate, or otherwise control one or more functions of the deployable unit 130.

In one or more examples, the command unit 120 includes at least one command communicating device 192. The command communicating device 192 generates command communication signals 202. In one or more examples, the command communicating device 192 is coupled to and is in communication with the controlling device 188, which is used to initiate, terminate, or otherwise control one or more functions of the command communicating device 192. The command communicating device 192 is coupled to the command access point 122. In one or more examples, the command communication signals 202 are transmitted to the host access point 112 and are broadcast by the host unit 110. In one or more examples, the command communication signals 202 are transmitted to the deployable access point 132, via the host access point 112, and are broadcast by the deployable unit 130 (e.g., deployable observing devices 194, deployable broadcasting device 196, and/or deployable communicating devices 198). In one or more examples, deployable communication signals 206 are transmitted to the command access point 122 from the deployable access point 132, via the host access point 112, and are delivered or broadcast to the command unit 120 (e.g., by the command communicating device 192). As examples, the command communication signals 202 can be audio signals (e.g., voice), video signals (e.g., video), data signals (e.g., data), and the like. Examples of the command communicating device 192 include a wireless headset 244, a wired headset 242, a speaker 246, a camera 248, a microphone 252, an intercom 254, a display 256, and other devices that enable one-way or two-way transmission of information between the command unit 120 and the host unit 110 and/or the deployable unit 130.

Referring to FIGS. 1 and 3, in one or more examples, the host unit 110 includes at least one host broadcasting device 184. In one or more examples, the host broadcasting device 184 is configured to relay, display, or announce the command communication signals 202 received from the command unit 120. In one or more examples, the control signals 208 are used to initiate, terminate, or otherwise control one or more functions of the host broadcasting device 184. As an example, an audio (e.g., real-time or pre-recorded) message can be broadcast by the host broadcasting device 184 in response to receiving the command communication signals 202 from the command unit 120. As another example, an audio tone, siren, or similar sound can be broadcast by the host broadcasting device 184 in response to the receiving the control signal 208 from the command unit 120. As an example, a video (e.g., real-time or pre-recorded) message can be broadcast by the host broadcasting device 184 in response to receiving the command communication signals 202 from the command unit 120. Examples of the host broadcasting device 184 include, but are not limited to, the speaker 246, the display 256, and other devices that enable one-way transmission of information from the command unit 120 to the host unit 110.

In these examples, the command communicating device 192 generates the command communication signals 202. The command access point 122 transmits the command communication signals 202 to the host access point 112. The host broadcasting device 184 broadcasts the command communication signals 202 to a target audience.

Referring to FIGS. 1 and 3, in one or more examples, the host unit 110 includes at least one host observing device 182. In one or more examples, the host observing device 182 is configured to monitor an area around the host unit 110 and collect input (e.g., audio and/or video), information, intelligence, and/or other data from the area surrounding the host unit 110. The host observing device 182 is further configured to generate and/or relay such information in the form of host communication signals 204. In one or more examples, the host communication signals 204 are transmitted to the command access point 122 and are relayed to the operator of the command unit 120. In one or more examples, the control signals 208 are used to initiate, terminate, or otherwise control one or more functions of the host observing device 182. As examples, the host communication signals 204 can be audio signals (e.g., voice), video signals (e.g., video), data signals (e.g., data), and the like. Examples of the host observing device 182 include, but are not limited to, the microphone 252, the camera 248, a sensor 258, and other devices that enable one-way transmission of information from the host unit 110 to the command unit 120.

In these examples, the host observing device 182 generates the host communication signals 204. The host access point 112 transmits the host communication signals 204 to the command access point 122. The command communicating device 192 relays the host communication signals 204 to the operator of the command unit 120.

Referring to FIG. 3, in one or more examples, at least one host observing device 182 and at least one host broadcasting device 184 of the host unit 110 are integrated into a host communicating device 186, which is a single functional component of the host unit 110 that enables both collecting and broadcasting of different types of information and signals. Examples of the host communicating device 186 are the intercom 254 or other devices that enable two-way transmission of information between the host unit 110 and the command unit 120.

In these examples, the command communicating device 192 generates the command communication signals 202. The command access point 122 transmits the command communication signals 202 to the host access point 112. The host communicating device 186 broadcasts the command communication signals 202 to a target audience. The host communicating device 186 generates the host communication signals 204. The host access point 112 transmits the host communication signals 204 to the command access point 122. The command communicating device 192 relays the host communication signals 204 to the operator of the command unit 120.

Referring to FIGS. 1 and 5, in one or more examples, the deployable unit 130 includes at least one deployable broadcasting device 196. In one or more examples, the deployable broadcasting device 196 is configured to relay, display, or announce the command communication signals 202 received from the command unit 120, via the host unit 110. In one or more examples, the control signals 208 are used to initiate, terminate, or otherwise control one or more functions of the deployable broadcasting device 196. As an example, an audio (e.g., real-time or pre-recorded) message can be broadcast by the deployable broadcasting device 196 in response to receiving the command communication signals 202 from the command unit 120, via the host unit 110. As another example, an audio tone, siren, or similar sound can be broadcast by the deployable broadcasting device 196 in response to the receiving the control signal 208 from the command unit 120, via the host unit 110. As an example, a video (e.g., real-time or pre-recorded) message can be broadcast by the deployable broadcasting device 196 in response to receiving the command communication signals 202 from the command unit 120, via the host unit 110. Examples of the deployable broadcasting device 196 include, but are not limited to, the speaker 246, the display 256, and other devices that enable one-way transmission of information from the command unit 120 to the deployable unit 130, via the host unit 110.

In these examples, the command communicating device 192 generates the command communication signals 202. The command access point 122 transmits the command communication signals 202 to the host access point 112. The host access point 112 transmits the command communication signals 202 to the deployable access point 132. The deployable broadcasting device 196 broadcasts the command communication signals 202 to a target audience.

In one or more examples, the deployable unit 130 includes at least one deployable observing device 194. In one or more examples, the deployable observing device 194 is configured to monitor an area around the deployable unit 130 and collect input (e.g., audio and/or video), information, intelligence, and/or other data from the area surrounding the deployable unit 130. The deployable observing device 194 is further configured to generate and/or relay such information in the form of deployable communication signals 206. In one or more examples, the deployable communication signals 206 are transmitted to the command access point 122, via the host unit 110, and are relayed to the operator of the command unit 120. In one or more examples, the control signals 208 are used to initiate, terminate, or otherwise control one or more functions of the deployable observing device 194. As examples, the deployable communication signals 206 can be audio signals (e.g., voice), video signals (e.g., video), data signals (e.g., data), and the like. Examples of the deployable observing device 194 include, but are not limited to, the microphone 252, the camera 248, the sensor 258, and other devices that enable one-way transmission of information from the deployable unit 130 to the command unit 120, via the host unit 110.

In these examples, the deployable observing device 194 generates the deployable communication signals 206. The deployable access point 132 transmits the deployable communication signals 206 to the host access point 112. The host access point 112 transmits the deployable communication signals 206 to the command access point 122. The command communicating device 192 relays the deployable communication signals 206 to the operator of the command unit 120.

In one or more examples, at least one deployable observing device 194 and at least one deployable broadcasting device 196 of the deployable unit 130 are integrated into a deployable communicating device 198, which is a single functional component of the deployable unit 130 that enables both collecting and broadcasting of different types of information and signals. Examples of the deployable communicating device 198 are the intercom 254 or other devices that enable two-way transmission of information between the deployable unit 130 and the command unit 120, via the host unit 110.

In these examples, the command communicating device 192 generates the command communication signals 202. The command access point 122 transmits the command communication signals 202 to the host access point 112. The host access point 112 transmits the command communication signals 202 to the deployable access point 132. The deployable communicating device 198 broadcasts the command communication signals 202 to a target audience. The deployable communicating device 198 generates the deployable communication signals 206. The deployable access point 132 transmits the deployable communication signals 206 to the host access point 112. The host access point 112 transmits the deployable communication signals 206 to the command access point 122. The command communicating device 192 relays the deployable communication signals 206 to the operator of the command unit 120.

Referring to FIGS. 1 and 5, in one or more examples, the system 100 includes a mobile handset 262. In one or more examples, the handset 262 is an example of the deployable communicating device 198. In one or more examples, the handset 262 is associated with or is used in conjunction with the deployable unit 130 but is separate from the deployable unit 130. The handset 262 is configured to communicate wirelessly with the deployable access point 132. Generally, the handset 262 includes various functional components common to portable handsets for mobile communication or devices, such as, but not limited to, a receiver, a transmitter, an antenna, a CPU, and the like. In the negotiations example, the handset 262 can be delivered or deployed following initial use of the deployable unit 130 or in situations one-on-one or private communications is desired between the negotiator and the perpetrator.

In one or more examples, the deployable access point 132 is configured to generate a second area network 138. The second area network 138 enables wireless connectivity, communication, and control between the deployable unit 130 and the handset 262. In other words, in some examples, the deployable unit 130 (e.g., the deployable access point 132) is a secondary ad hoc network host for a smaller wireless network used for communication between the handset 262 and the deployable access point 132.

The deployable access point 132 is configured to communicate with the handset 262 over the second area network 138. As an example, the deployable access point 132 and the handset 262 establish and communicate via wireless connection over the second area network 138.

Referring to FIG. 1, in one or more examples, the deployable unit 130 (e.g., deployable access point 132) and the handset 262 wireless communicate with each other over the second area network 138 using a second frequency 174. The second frequency 174 can by any suitable frequency depending on the application of the system 100, the location of use, government regulations, and the like. In one or more examples, the second frequency 174 and the first frequency 172 are different. In one particular example, the second frequency 174 is 2.4 GHz.

Referring to FIG. 5, in one or more examples, the deployable access point 132 includes a network bridge 218. The network bridge 218 is configured to integrate the wireless signals or data stream received by the handset 262 over the second area network 138 using the second frequency 174 into wireless signals or data stream transmitted over the area network 102 using the first frequency 172. In one or more examples, the network bridge 218 takes the form of a software patch the connects the second frequency 174 to the first frequency 172 by routing the signal received by one of the deployable radios 164 (transceivers) using the second frequency 174 to another one of the deployable radios 164 (transceivers using the first frequency 172.

Referring to FIGS. 5-8, in one or more examples, one of the plurality of deployable antennas 136, such as the deployable omnidirectional antenna 168, is configured for dedicated communications with the handset 262 over the second area network 138 using the second frequency 174. In these examples, others of the plurality of deployable antennas 136, such as the deployable directional antennas 166, are configured to dedicated communications with the host unit 110 (e.g., host access point 112) over the area network 102 using the first frequency 172.

In these examples, the system 100 enables utilization of various numbers and/or implementations of the deployable broadcasting device 196, deployable observing device 194, and/or deployable communicating device 198 that operate on a different network (e.g., second area network 138) and/or communicate using a different frequency (e.g., second frequency 174), which would otherwise not connect directly to the host unit 110 (e.g., host access point 112) over the area network 102 using the first frequency 172.

Referring to FIGS. 3-5, in one or more examples, at least some of the functional components of the system 100, such as at least some of the functional components of the host unit 110, the command unit 120, and/or the deployable unit 130 are network enables devices configured to operate and automatically communicate using internet protocol. In one or more examples, each one of the function components of the system 100 has its own dedicated and assigned static IP address 354 for communication within the system 100. Use of network enabled devices, each with a unique static IP address 354, simplifies the system 100 and enables interchangeability and/or replacement of components as needed.

In one or more examples, at least some of the host broadcasting devices 184 (e.g., speaker 246, etc.), the host observing devices 182 (e.g., microphone 252, camera 248, sensor 258, etc.), and/or the host communicating device 186 (e.g., intercom 254, etc.) are network enabled devices configured to operate and automatically connect and communicate with the host access point 112 using internet protocol. In these examples, each one of the network-enabled examples of the host broadcasting devices 184, the host observing devices 182, and/or the host communicating devices 186 has its own unique, dedicated, and assigned static IP address 354 for communication within the system 100.

In one or more examples, at least some of the deployable broadcasting devices 196 (e.g., speaker 246, etc.), the deployable observing devices 194 (e.g., microphone 252, camera 248, sensor 258, etc.), and/or the deployable communicating device 198 (e.g., intercom 254, etc.) are network enables devices configured to operate and automatically connect and communicate with the deployable access point 132 using internet protocol. In these examples, each one of the network-enabled examples of the deployable broadcasting devices 196, the deployable observing devices 194, and/or the deployable communicating devices 198 has its own unique, dedicated, and assigned static IP address 354 for communication within the system 100.

As another example, at least some of the command communicating devices 192 (e.g., wireless headset 244, speaker 246, display 256, camera 248, microphone 252, etc.) are network enabled devices configured to operate and automatically connect and communicate with the command access point 122 using internet protocol. In these examples, each one of the network-enabled examples of the command communicating devices 192 has its own unique, dedicated, and assigned static IP address 354 for communication within the system 100.

In other examples, some of the functional components of the system 100, such as some of the functional components of the host unit 110, the command unit 120, and/or the deployable unit 130 are non-network-enabled devices that are not configured to operate and automatically communicate using internet protocol. In these examples, the system 100 includes various other hardware and/or software components that enable connection and communication with the access points.

In one or more examples, the command unit 120, such as the command access point 122, includes a command processor 152 configured to enable connection and communication with non-network-enabled examples of the command communicating devices 192. In one or more examples, the host unit 110, such as the host access point 112, includes a host processor 142 configured to enable connection and communication with non-network-enabled examples of the host broadcasting devices 184, host observing devices 182, and/or host communicating devices 186. In one or more examples, the deployable unit 130, such as the deployable access point 132, includes a deployable processor 162 configured to enable connection and communication with non-network-enabled examples of the deployable broadcasting devices 196, deployable observing devices 194, and/or deployable communicating devices 198.

In one or more examples, the command unit 120, such as the command access point 122, includes a command input/output (I/O) device 224 (e.g., plurality of I/O ports) configured to enable wired connection of one or more of the command communicating devices 192. In one or more examples, the host unit 110, such as the host access point 112, includes a host I/O device 222 (e.g., plurality of I/O ports) configured to enable wired connection of one or more of the host broadcasting devices 184, host observing devices 182, and/or host communicating devices 186. In one or more examples, the deployable unit 130, such as the deployable access point 132, includes a deployable I/O device 226 (e.g., plurality of I/O ports) configured to enable wired connection of one or more of the deployable broadcasting devices 196, deployable observing devices 194, and/or deployable communicating devices 198.

Referring to FIGS. 5-9, in one or more examples of the system 100, the deployable unit 130 includes any number of deployable broadcasting devices 196, deployable observing devices 194, and/or deployable communicating devices 198, which can be integrated within one structural element or enclosure (e.g., deployable case 236) or separated into multiple independently operated and remote functional components. In an illustrative example, the deployable unit 130 includes the deployable broadcasting device 196 (e.g., intercom 254), which is integrated into the enclosure of the deployable unit 130, the deployable communicating device 198 (e.g., handset 262), which is remote and communicates wirelessly with the deployable access point 132 over the second area network 138, and the deployable observing device 194 (e.g., camera 248), which is remote and communicates wirelessly with the deployable access point 132 over the second area network 138.

In one or more examples, the system 100 includes any suitable number of the deployable units 130 depending on the situation or application of the system 100. In these examples, each one of the deployable units 130 may have different operational functions and/or capabilities. Each one of the deployable units 130 communicates with the host unit 110 over the area network 102. In an illustrative example, one of the deployable units 130 takes the form on the throw case (e.g., deployable case 236) and includes at least one deployable communicating device 198. One of the deployable broadcasting devices 196 (e.g., intercom 254) is integrated within the enclosure (e.g., deployable case 236) of the deployable unit 130 and another one of the deployable broadcasting devices 196 (e.g., handset 262) communicates wirelessly with the deployable units 130 (e.g., deployable access point 132) over the second area network 138. Another one of the deployable units 130 takes the form of the deployable observing device 194 (e.g., camera 248) and communicates wirelessly with the host unit 110 over the area network 102.

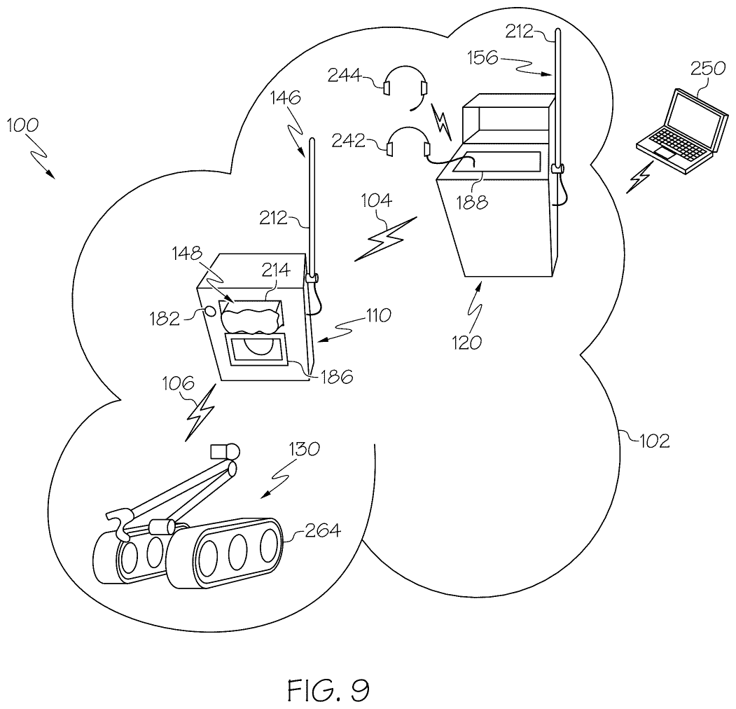

Referring to FIG. 9, in one or more examples, the deployable units 130 can take the form of various other functional and/or controllable devices. As an example, the deployable units 130 include or take the form of a robot 264. In these examples, the deployable units 130 (e.g., robot 264) includes the deployable access point 132, the deployable antennas 136, and all other components required for communication with the host unit 110 over the area network 102. In these examples, an operator can control the robot 264 from the command unit 120.

Referring to FIG. 4, in one or more examples, the command unit 120 includes a user interface (UI) 228, or other operator interface. The user interface 228 is coupled to, is in communication with, or forms a portion of the controlling device 188. In one or more examples, part of the command communicating device 192 or a portion of the functionality of the command communicating device 192 (e.g., microphone 252, speaker 246, display 256, etc.) is integrated into the user interface 228. In one or more examples, the user interface 228 enables the operator of the command unit 120 to input the control signals 208 for the controlling device 188. In one or more examples, the user interface 228 enables the operator of the command unit 120 to view or listen to the host communication signals 204 and/or the deployable communication signals 206 received by the command unit 120.

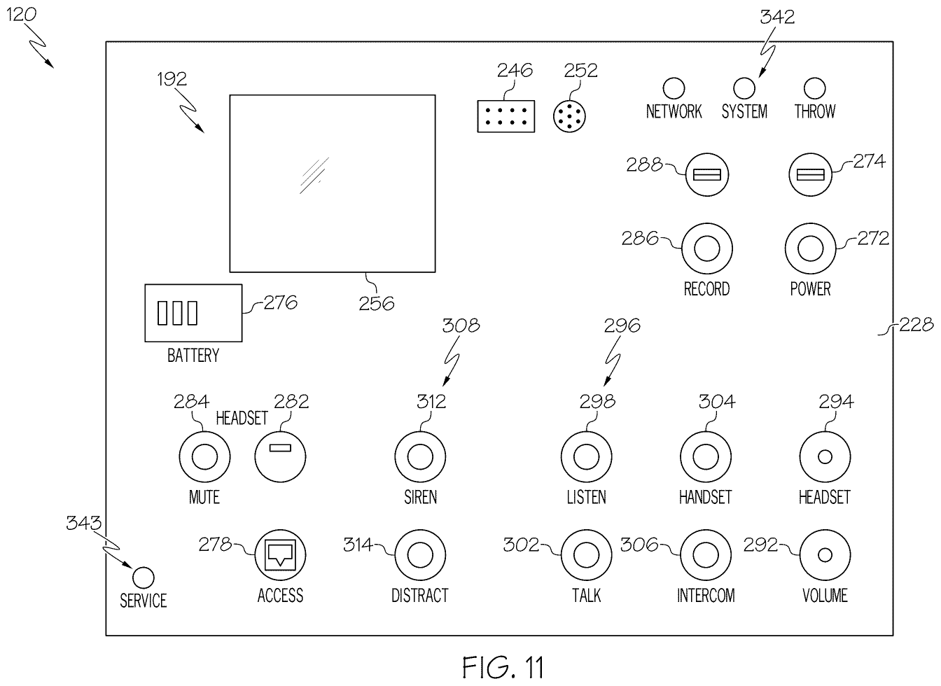

FIG. 11 illustrates an example of the user interface 228 of the command unit 120. In one or more examples, the user interface 228 serves as a control panel for the command unit 120 and the controlling device 188. In these examples, the user interface 228 includes a plurality of buttons, switches, plugs, and the like that enable the operator to initiate, terminate, and/or control various functions of the system 100 and communication between the various components of the system 100. In one or more examples, the user interface 228 includes a power switch 272 (e.g., master ON/OFF button) for energizing the command unit 120, a charging port 274 for charging ancillary devices (e.g., mobile phone), a battery indicator 276, and an access port 278 that enables wired connection of a computer (e.g., computer 250). In one or more examples, the user interface 228 includes various implementations of the one command communicating device 192, such as the display 256 (e.g., touch screen), the speaker 246, the microphone 252, a dongle port 282 for connection of a wireless implementation of one of the command communicating devices 192 (e.g., wireless headset 244), a mute button 284 for muting outgoing audio, a volume control 292, an audio/video (A/V) jack 294 for connection of a wired implementation of one of the one command communicating device 192 (e.g., headset 242), and the like. In one or more examples, the user interface 228 includes a record button 286 that initiates recording of the incoming and outgoing audio and/or video streams, such as command communication signals 202, host communication signals 204, and deployable communication signals 206, and a memory port 288 for connecting an external memory unit configured to save the recorded data files. In one or more examples, the user interface 228 includes any number of communication buttons 296 or switches. In these examples, each one of the communication buttons 296 initiates, terminates, and/or controls communication between one of the components of the system 100. In these examples, each one of the communications components of the system 100 corresponds to one of the communication buttons 296, such that when actuated or engaged the command unit 120 automatically connects to the static IP address of the corresponding component (e.g., one of the one host observing devices 182, host broadcasting devices 184, host communicating devices 186, deployable observing devices 194, deployable broadcasting devices 196, deployable communicating device 198, etc.). In one or more examples, the communication buttons 296 includes a listen button 298 that initiates a one-way communications data stream from the host unit 110 or the deployable units 130 back to the command unit 120, such as from the host observing device 182, the host communicating device 186, the deployable observing device 194, or the deployable communicating device 198. In one or more examples, the communication buttons 296 include a talk button 302 that initiates a one-way communications data stream from the command unit 120 to one of the host unit 110 or the deployable units 130, such as to the host broadcasting devices 184, host communicating device 186, deployable broadcasting device 196, or deployable communicating device 198. In one or more examples, the communication buttons include a handset button 304 that initiates two-way communications data stream between the command unit 120 and the handset 262 of the deployable unit 130. In one or more examples, the communication buttons include an intercom button 306 that initiates two-way communications data stream between the command unit 120 and the intercom 254 of the deployable unit 130. In one or more examples, the user interface 228 includes any number of action buttons 308 or switches. In these examples, each one of the communication buttons 296 automatically initiates, terminates, and/or controls some function of one or more of the components of the host unit 110 and/or the deployable units 130. As examples, the action buttons 308 includes a siren button 312 which automatically initiates a siren sound from one or more of the host broadcasting devices 184, deployable broadcasting device 196, and the like, and a distract button 314, which automatically a distraction tone from one or more of the host broadcasting devices 184, deployable broadcasting device 196, and the like. In one or more examples, the user interface 228 includes a plurality of system indicator lights 342 configured to indicate the status of network functionality, connectivity between the command unit 120, the host unit 110, and/or the deployable unit 130, communications between the command unit 120, the host unit 110, and/or the deployable unit 130, and/or operational status of the command unit 120, the host unit 110, and/or the deployable unit 130. In one or more examples, the user interface 228 also includes at least one service indicator light 343, which is configured to indicate an error in the system 100. In these examples, the command unit 120 is configured to generate an error log that can be transmitted to the computer 250. The examples of the user interface 228 and the various components thereof are provided as examples and should not be interpreted as limiting the configuration or functional capabilities of the command unit 120.

Referring to FIGS. 3 and 6-10 in one or more examples, the host unit 110 includes a host case 232. The host case 232 serves an exterior enclosure or housing for the operational components of the host unit 110. In one or more examples, the host unit 110 also includes other functional components, including, but not limited to, a host battery 364, host charging ports, host electrical connections, host solar cells 344, host power converters, host wiring and harnesses, and the like. In one or more examples, the host antenna 116 (e.g., host omnidirectional antenna 146 and/or host directional antenna 148) is coupled to an exterior of the host case 232. In one or more examples, the host antenna 116 (e.g., host omnidirectional antenna 146 and/or host directional antenna 148) is removable from the exterior of the host case 232.

Referring to FIGS. 4 and 6-10, in one or more examples, the command unit 120 includes a command case 234. The command case 234 serves as an exterior enclosure or housing for the operational components of the command unit 120. In one or more examples, the command unit 120 also includes other functional components, including, but not limited to, a command battery 346, command charging ports, command electrical connections, command solar cells 348, command power converters, command wiring and harnesses, and the like. In one or more examples, the command antenna 126 (e.g., command omnidirectional antenna 156) is coupled to an exterior of the command case 234. In one or more examples, the command antenna 126 (e.g., command omnidirectional antenna 156) is removable from the exterior of the host case 232.

Referring to FIGS. 5-8, in one or more examples, the deployable unit 130 includes the deployable case 236. In these examples, the deployable case 236 serves as an exterior enclosure or housing for the operational components of the deployable unit 130. In one or more examples, the deployable unit 130 also includes other functional components, including, but not limited to, a deployable battery 352, deployable charging ports, deployable electrical connections, deployable solar cells, deployable power converters, deployable wiring and harnesses, and the like. In one or more examples, the deployable antenna 136 (e.g., deployable omnidirectional antenna 168 and/or deployable directional antenna 166) is coupled to an interior of the deployable case 236. In one or more examples, the deployable case 236 includes a plurality of antenna mounts 322.

In one or more examples, the antenna mounts 322 are configured to retain the deployable antennas 136, such as the deployable directional antennas 166 (e.g., three sector antennas 216) and/or the deployable omnidirectional antenna 168 in a desired position and/or orientation. In one or more examples, the antenna mounts 322 are made of a nonmetallic material. In one or more examples, the deployable directional antennas 166 (e.g., three sector antennas 216) are situated at three corners of the deployable case 236. In these examples, the sector antennas 216 are angularly spaced apart and provide 360-degree radiation coverage for wireless communication with the host unit 110, regardless of the position and/or orientation of the deployable case 236, such as after the deployable unit 130 is thrown into a hostile area. In one or more examples, the deployable omnidirectional antenna 168 is oriented at a 45-degree angle relative to horizontal and vertical. In these examples, the orientation of the deployable omnidirectional antenna 168 enables radiation coverage and wireless communication with the remote instances of the deployable observing device 194, deployable broadcasting device 196, and/or deployable communicating device 198 (e.g., handset 262) in non-orthogonal orientations regardless of how the deployable unit 130 is situated or oriented.

In one or more examples, the deployable unit 130 includes a plurality of studs 338. The studs 338 project from at least a portion of the exterior of the deployable case 236. The studs 338 enable the deployable case 236 to break glass upon being deployed.

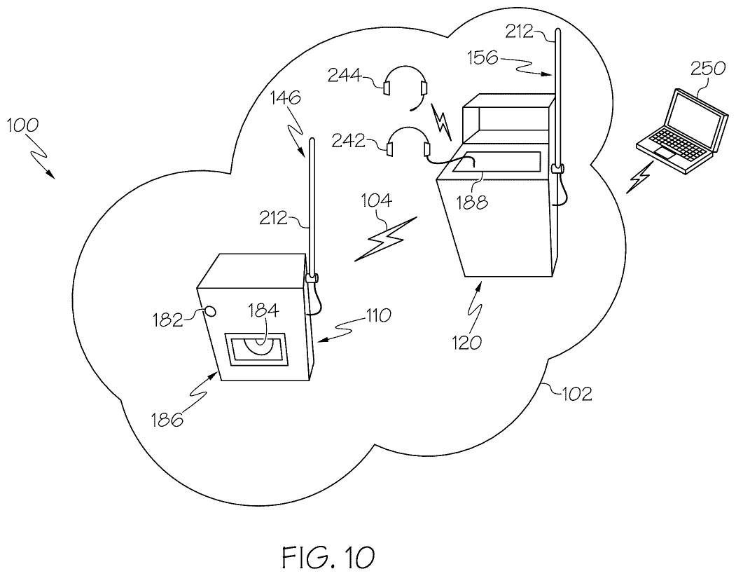

Referring to FIG. 10, in one or more examples or operational situations, the system 100 includes or utilizes only the host unit 110 and the command unit 120. As an example, the host unit 110 generates the area network 102. The command unit 120 communicates with the host unit 110 over the area network 102. In one or more examples, the host unit 110 includes at least one host observing device 182. The host observing device 182 is configured to observe and monitor the situation and generate and/or provide real-time information about the situation, such as audio data, video data, sensor data, and the like. This information is wirelessly transmitted from the host unit 110 to the command unit 120. The operator of the command unit 120 is then able to process and react based on the information provided by the host unit 110. In these examples, the host unit 110 can provide relatively clandestine observation of a situation. As another example, the host unit 110, additionally or alternatively, includes at least one host broadcasting device 184. Audio and/or video is wirelessly transmitted from the command unit 120 to the host unit 110. The host broadcasting device 184 is configured to broadcast, transmit, or relay the audio and/or video to a desired target within range of the host unit 110. In these examples, the host unit 110 can provide remote communication of information and/or broadcast of announcements to the desired target.

Referring to FIGS. 3-5, in one or more examples, the host unit 110, the command unit 120, and/or the deployable units 130 can include various other features, elements, and/or components that enhance the functionality and/or effectiveness of the system 100 depending on the operational application of the system 100.

In one or more examples, the host unit 110 includes host shielding 356 that is configured to protect the functional components of the host unit 110. In one or more examples, the host shielding 356 is situated or enclosed within the host case 232 and protects the components of the host unit 110 within the host case 232 (e.g., host access point 112, host battery 364, etc.). Examples of the host shielding 356 include bullet proof shielding, electromagnetic shielding, and the like.

In one or more examples, the command unit 120 includes command shielding 358 that is configured to protect the functional components of the command unit 120. In one or more examples, the command shielding 358 is situated or enclosed within the command case 234 and protects the components of the command unit 120 within the command case 234 (e.g., command access point 122, command battery 346, etc.). Examples of the command shielding 358 include bullet proof shielding, electromagnetic shielding, and the like.

In one or more examples, the deployable unit 130 includes deployable shielding 362 that is configured to protect the functional components of the deployable unit 130. In one or more examples, the deployable shielding 362 is situated or enclosed within the deployable case 236 and protects the components of the deployable unit 130 within the deployable case 236 (e.g., deployable access point 132, deployable battery 352, etc.). Examples of the deployable shielding 362 include bullet proof shielding, electromagnetic shielding, and the like.

In one or more examples, the host unit 110 includes a host frame 324 situated within the host case 232. The host frame 324 is a rigid structure formed of a plurality of frame members that serve to support the host case 232 and/or operating components of the host unit 110 contained within the host case 232. As an example, one or more of the host access point 112, or any of the components thereof, can be mounted to the host frame 324 within the host case 232. As another example, interior portions of the host broadcasting device 184, the host observing device 182, and/or the host communicating device 186 can be mounted to the host frame 324.

In one or more examples, the command unit 120 includes a command frame 326 situated within the command case 234. The command frame 326 is a rigid structure formed of a plurality of frame members that serve to support the command case 234 and/or operating components of the command unit 120 contained within the command case 234. As an example, one or more of the command access point 122, or any of the components thereof, can be mounted to the command frame 326 within the command case 234. As another example, interior portions of the command broadcasting device 192 can be mounted to the command frame 326.

In one or more examples, the deployable unit 130 includes a deployable frame 328 situated within the deployable case 236. The deployable frame 328 is a rigid structure formed of a plurality of frame members that serve to support the deployable case 236 and/or operating components of the deployable unit 130 contained within the deployable case 236. As an example, one or more of the deployable access point 132, or any of the components thereof, can be mounted to the deployable frame 328 within the deployable case 236. As another example, the antenna mounts 322 can be integrated with, formed by, or attached to the deployable frame 328. As another example, interior portions of the deployable broadcasting device 196, the deployable observing device 194, and/or the deployable communicating device 198 can be mounted to the command frame 326.

Referring to FIGS. 1 and 6-10, in one or more examples, the system 100 includes the computer 250. The computer 250 includes any suitable computing device and includes one or more processors and one or more computer-readable storage devices, storing instructions or computer-readable program code, which are executed by the one or more processors to perform various operations of the computer 250. In one or more examples, the computer 250 is coupled to the command unit 120, wired or wirelessly, and communicates with the controlling device 188. In various examples, the computer 250 can communicate with the command unit 120 directly, with the host unit 110 indirectly through the command unit 120, and with the deployable unit 130 indirectly through the command unit 120 and the host unit 110. The computer 250 provides updates and functional commands to the system 100.

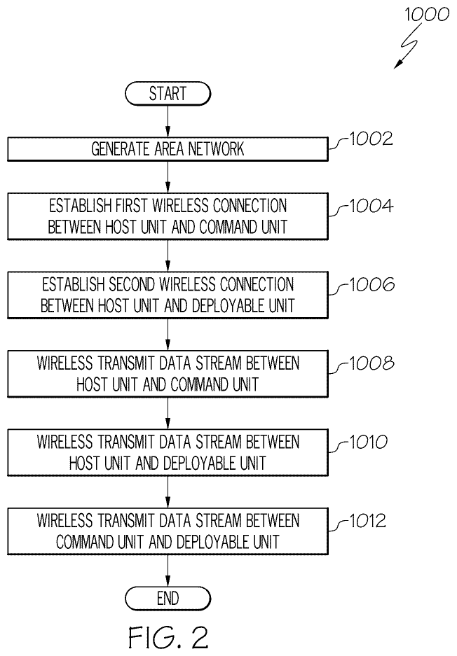

Referring now to FIG. 2, the following are examples of the method 1000, according to the present disclosure. The method 1000 includes a number of elements, steps, operations, or processes. Not all of the elements, steps, operations, or processes described or illustrated in one example are required in that example. Some or all of the elements, steps, operations, or processes described or illustrated in one example can be combined with other examples in various ways without the need to include other elements, steps, operations, or processes described in those other examples, even though such combination or combinations are not explicitly described or illustrated by example herein.

Referring generally to FIGS. 1 and 3-11 and particularly to FIG. 2, in one or more examples, the method 1000 is implemented using the system 100.

In one or more examples, the method 1000 includes a step of generating 1002 the area network 102 with the host access point 112. The method 1000 includes a step of establishing 1004 the first peer-to-peer wireless connection 104 between the host access point 112 and the command access point 122 over the area network 102. The method 1000 includes a step of establishing 1006 the second peer-to-peer wireless connection 106 between the host access point 112 and the deployable access point 132 over the area network 102. The method 1000 includes a step of wirelessly transmitting 1008 a data stream between the host access point 112 and the command access point 122. The method 1000 includes a step of wirelessly transmitting 1010 the data stream between the host access point 112 and the deployable access point 132. The method 1000 includes a step of wirelessly transmitting 1012 the data stream between the command access point 122 and the deployable access point 132 via the host access point 112.

Some of the examples disclosed herein relate to the field of hostage negotiation and rugged remote communication devices, and more particularly, to providing a means for safe hostage negotiation to the hostage negotiator. Thus, some examples relate to pelican-style boxes that can be thrown into a hostile area with a hostage-taker. However, the illustrative examples are intended to include or otherwise cover other applications, such as in any context in the communication industry, including but not limited to high-risk situations, search and rescue operations, disaster relief, mental health interventions, border control and immigration, remote communication training, medical situations, educational settings, or any other application that may be useful.

In various illustrative examples disclosed herein, the system 100 is a bulletproof communication system designed for hostage negotiation and high-stress situations. The system 100 includes a rugged communication box, or “throw case,” that can be safely deployed near a hostage taker and hostages, along with a receiver box, or “negotiator box,” for negotiators. The bulletproof communication box is constructed to withstand extreme conditions, utilizing a durable and impact-resistant case. The communication box can be built as a pelican-style case that features a seal on the inside of the lid and one or more clips to keep the lid closed when not in use. Inside, an electrical board with an intricate network of wires powers the system. A strategically chosen battery ensures sustained operation, while antennae facilitate long-distance communication. The audio transmitting system, equipped with a high-quality microphone and speaker, completes the package, enabling two-way audio communication between the negotiator and the hostage taker. The antennae primarily utilize radio frequencies to communicate over distances ranging from ¾ to up to 2 miles. The receiver box can be outfitted with a variety of instruments to allow a multitude of operations and analysis that can be useful for both the hostage situation as well as subsequent criminal prosecution. Examples include but are not limited to a programmable soundboard, USB storage for recording, adjustable volume controls, data indicator lights, data analysis screens, etc. The design of the box is highly portable to allow the negotiator to change their positioning quickly and smoothly without a break in communication. Overall, this system allows negotiators to establish real-time communication from a secure distance, enhancing safety, enabling effective dialogue, and potentially preventing violent outcomes. Applications of the system 100 extend beyond hostage negotiation to various high-risk scenarios, where maintaining a safe distance while communicating is crucial.

In various examples, the exterior cases utilize a pelican-style that offers several significant benefits in high stress situations like hostage negotiations and other critical incidents. Pelican-style cases are engineered to withstand extreme conditions, including impacts, drops, and vibrations. This robust construction ensures that the communication equipment inside remains intact and functional even in chaotic or intense situations. In some examples, the case includes a neoprene seal on the inside of the lid to prevent water, dust, and other environmental factors from damaging the sensitive communication equipment, ensuring that the system 100 remains operational regardless of the external conditions. In some examples, the cases may come with customizable foam or rubber inserts. These inserts can be precisely tailored to securely cradle the communication equipment, preventing any movement that might lead to damage during transport or deployment. In some examples, the case can be designed to be bulletproof by utilizing strong materials and mechanical connections. While achieving complete invulnerability is challenging, a well-designed bulletproof case can significantly enhance the durability of the communication system. In some examples, the exterior materials can be formed from ballistic fiber composites: Kevlar, Spectra, and Dyneema are lightweight and flexible ballistic fiber composites used in body armor due to their excellent strength-to-weight ratio. In some examples, the exterior of the case may also utilize aluminum or titanium alloys for added strength, and hard armor plates composed of ceramics or advanced composites that provide rigid ballistic resistance. In some examples, the case can be crafted with layered construction using multiple materials like ballistic fibers and hard armor for comprehensive protection. In some examples, the case can be designed with reinforced corners and edges to distribute impact forces and minimize vulnerabilities, as well as curved surfaces to deflect projectiles and disperse energy. Sealed joints and high-quality latches to prevent bullet penetration and maintain case integrity are another effective measure that may be designed into several examples. In some examples, the cases include ergonomic handles, rolling wheels, and stacking capabilities, making them easy to transport to the negotiation site or other locations. This mobility ensures that the communication system can be rapidly deployed to the necessary area. In some examples, the case may be equipped with secure locking mechanisms that prevent unauthorized access to the equipment inside. This adds an additional layer of security, crucial for maintaining the integrity of the communication system. These locking mechanisms include but are not limited to manual clips, automatic password locks, padlocks, etc.

In some examples, the units of the system are primarily battery powered. Given the need for portability, longevity, and efficient power supply, rechargeable lithium-ion (Li-ion) or lithium-polymer (LiPo) batteries are used in some examples. These batteries offer high energy density, longer lifespan, and can be recharged for repeated use. In some examples, the units may use a 24 V cell with a capacity of 100 Ah, which may allow the system to run for up to 6 weeks. In some examples, the units utilize a rechargeable battery that may power the internal components for up to 14 days. In some embodiments, the battery capacity may be increased to allow for negotiations that last longer than 14 days. In some examples, the units have the option for plug-in power as well as a charging mechanism for recharging the battery after use. Implementing an effective power management system is crucial to ensure optimal use of the battery's capacity. In some examples, the system may include voltage regulation, current limiting, and protection mechanisms to prevent overcharging, over-discharging, and short circuits. In some examples, the system's energy efficiency may be optimized by implementing sleep modes or power-saving features for components that are not in active use. This can significantly extend the battery's life during periods of low activity. Some examples incorporate a battery monitoring system that provides real-time information about the battery's state of charge, voltage, and temperature. This information allows users to make informed decisions and avoid unexpected power loss. Some examples position the battery within the case in a way that balances weight distribution and thermal management. Adequate ventilation and heat dissipation mechanisms may also be included in some embodiments to prevent overheating.

In various examples, the system units are equipped with adequate audio equipment so that the negotiator's voice is heard clearly in any environment. In some examples, a single midrange speaker is sufficient. However, some other examples may be equipped with multiple speakers. In some examples, these multiple speakers may have different frequency range responses, such as a woofer with a frequency response between 20 Hz and 2,000 Hz, a midrange driver with a frequency response between 500 Hz and 4,000 Hz, and a tweeter with a frequency response between 2,000 Hz and 20,000 Hz. In some examples, directional or focused speakers may be used to emit sound in a specific direction, concentrating the audio towards the intended recipient while minimizing sound dispersion in the surroundings. This helps ensure that the intended audience hears the message clearly without causing excessive noise pollution in the environment. In some examples, high-powered amplifiers may be included to enhance the volume output of the speaker without sacrificing audio quality. This is particularly useful in noisy environments where ambient sounds might interfere with communication. In some examples, units can be equipped with a high-quality microphone to ensure the hostage taker's voice is effectively heard by the negotiator. In some examples, one or more directional microphones may be used, such as a system of shotgun microphones, are sensitive to sound from a specific direction. This design helps isolate the hostage taker's voice while reducing ambient noise from other directions. In some examples, the microphone is sensitive enough to pick up faint noises or quiet speech from a distance. In some examples, the units are equipped with a built-in microphone. In some examples, the units include one or more audio jacks that can be used to connect an exterior microphone or headset. Some examples may include built-in equalization settings that allow for adjustments in bass, midrange, and treble frequencies. This feature can help optimize audio output for different environments. Some examples may incorporate other audio processing circuitry that can enhance the quality of audio transmission, including but not limited to echo cancellation, noise reduction, and feedback suppression. In some examples, microphone frequency filters may be used to remove noise or loud noises occurring at a known frequency, such as wind, rain, or traffic/construction noises.

In various examples, the system units utilize a reliable wireless connection for smooth and safe operation. In some examples, a set of radio frequency antennae are operated at frequency range near 4.9 GHZ, allowing for a range of at least ¾ of a mile and up to 2 miles in some situations. In some examples, dual-band connectivity is incorporated, which offers flexibility in choosing the most suitable frequency band based on the environment and potential interference. This adaptability ensures that the wireless connection remains stable in various scenarios. Some examples may also introduce automatic channel switching technology to prevent signal interference by continuously scanning and selecting the optimal wireless channel. This minimizes disruptions and maintains a strong connection. In some examples, Bluetooth technology may be incorporated to enhance the versatility of the communication system. Bluetooth can facilitate short-range communication. This feature can be particularly useful for quick setup, configuration, and establishing the initial connection between the devices. In some examples, mesh networking capability may be introduced to allow multiple communication boxes to form a network, ensuring redundancy and extended coverage. This feature enables seamless communication even if one communication unit's connection is compromised, enhancing the system's reliability, and can be used to significantly increase the distance between the hostage taker and the hostage negotiator.

In various examples, security is considered in the design of the communication system, such as for hostage negotiation and other critical incidents, for several reasons, including prevention of interference and confidentiality among others. To enhance the security of the system, examples may include several security features. In some examples, a dedicated Voice over Internet Protocol (VOIP) communication system is implemented. In some examples, this includes a Virtual Private Network (VPN) tunnel to ensure that the communication between the units remains confidential and protected. In some examples, these combined features allow for an invisible network that is undetectable even if a malicious party could pick up on the frequency. In some examples, the data stream may be encrypted with one of several algorithms, including but not limited to AES192, AES256, RSA, ECC, SHA, etc. In some examples, the system may be password protected to further increase security. In some examples, further security features may be implemented, such as incorporating biometric authentication methods, like fingerprint or facial recognition, which enhances security by tying access to unique physiological features, making unauthorized access more challenging. Some examples may integrate real-time threat monitoring software, which detects and alerts personnel about any unusual or suspicious activity within the system, enabling quick response to potential security breaches. Some examples include physical security measures, such as tamper-resistant locks, anti-tamper seals, and reinforced casing, among others. Some examples may also incorporate tamper detection mechanisms to alert authorized personnel if the system's physical integrity is compromised, such as an attempt to open the throw case or manipulate its components.

In various examples, a single audio connection is established between the units. In other examples, multiple external audio sources are used to enhance functionality. Some examples include the ability to connect external audio feeds, such as audio from surveillance cameras or remote microphones placed in different areas. This feature provides negotiators with additional perspectives on the situation, helping them gather crucial information. Some examples include the ability to connect the system to consulting parties, such as subject matter specialists or coaches. In some examples, this may be a simple set of external phone lines to call external parties. Some examples may allow for internet connectivity. It may be beneficial for some examples to allow negotiators to share relevant data with the external parties through one or more secure data-sharing interface. This enhances the consultant's ability to provide informed advice.

In various examples, the system 100 facilitates users having quick and immediate access to complex functions during the dialogue to enhance the effectiveness of negotiations. In various examples, the units are designed in a way that features can be quickly used. In some examples, a soundboard may be integrated to allow negotiators to play pre-recorded messages, tones, or sounds that can influence the negotiation dynamics. This feature can be used strategically to convey emotions, responses, or directives, enhancing communication effectiveness. In some examples, including volume controls for both incoming and outgoing audio ensures negotiators can adjust the audio levels to match the situation's noise level and maintain clear communication without causing discomfort. In some examples, volume controls may be a simple set of knobs and buttons. In some examples, a battery gauge may be displayed to inform negotiators about the remaining battery life of both the throw case and the negotiator box, ensuring they have a clear understanding of the system's operational duration and can plan accordingly. In some examples, a clock feature provides negotiators with a reference for time management, helping them stay aware of negotiation duration and deadlines. Some examples may also include the ability to set alarms and upcoming deadlines that can be easily displayed alongside the current time. In some examples, there may also be displays that show network connectivity and signal strength information to inform negotiators about the status of their wireless communication link, ensuring a stable connection for uninterrupted communication. Some examples may also include an LED or LCD screen to display multiple forms of information at the same time. In some examples, the units may include audio connection points such as RCA, BNC, XLR, TS, TRS, TRRS, or TRRRS jacks. Some examples include a push-to-talk function that allows negotiators to activate the consultant connection only when needed. This ensures that the connection is established purposefully, avoiding accidental disruptions. Some examples may display live transcription or include text-to-speech (TTS) capability to assist communication. Some examples allow users to customize sound profiles based on different negotiation scenarios. This ensures that the audio output is optimized for the specific environment and enhances clarity.

In various examples, the system 100 enables real-time data recording and analysis in that involves capturing, processing, and interpreting various types of data to aid negotiation strategies and decision-making. This approach enhances situational awareness and supports informed actions. Examples of sensors and other observing or monitoring devices include, but are not limited to, cameras, such as video cameras with a number of different lenses (wide angle, telephoto, etc.), record visual cues, body language, and interactions between participants; thermal imaging, such as thermal cameras are effective in low-light or complete darkness scenarios, ensuring visibility even when traditional cameras struggle to capture images and can even be used to capture images through objects that are transparent to IR wavelengths; temperature and humidity sensors or other environmental sensors monitor temperature and humidity levels, aiding in assessing the comfort and well-being of hostages; CO2 and gas sensors, such as gas and air quality sensors detect harmful gases or pollutants, providing information about air quality and potential threats; motion sensors detect movement within the negotiation environment, offering insights into participant dynamics; heart rate monitors, such as wearable heart rate monitors can provide real-time insights into the emotional state of hostages or negotiators; smoke detectors: can alert negotiators to the presence of fire or smoke, ensuring the safety of all involved; audio spectrum analyzers process audio data to identify specific frequencies or sounds that might carry particular significance; proximity sensors detect movement or the presence of individuals near the units; GPS module provides location data, enhancing situational awareness and coordination among team members; occupancy sensors determine the number of people in a room, helping negotiators gauge the situation's complexity.

Various examples may include one or more USB ports on one or more of the units, providing the physical interface for connecting USB storage devices. Some examples may include user-friendly controls that allow negotiators to start and stop USB recording easily. This can be done through physical buttons, touchscreen controls, or voice commands. Some examples may allow the USB device to record TTS transcripts of negotiations so that the data may be admissible in court procedures. In some examples, a number of natural language processing (NLP) algorithms may be used to assist negotiations. Some examples may utilize sentiment analysis to interpret the emotional tone of participants' speech. This provides negotiators with insights into the emotional state of the individuals involved. Some examples may extract key phrases and keywords from spoken conversations. This helps negotiators identify critical topics and subjects being discussed. Some examples may implement real-time summarization to condense lengthy conversations into concise summaries, enabling negotiators to quickly grasp essential points. Some examples may integrate language translation capabilities to facilitate communication in multilingual scenarios. Some examples may also assist the negotiator in executing effective negotiation strategies. Some examples integrate a feature that suggests possible responses or questions based on the context of the negotiation. This aids negotiators in formulating effective communication strategies. Some embodiments may analyze the flow of conversation to identify interruptions, shifts in topic, or recurring arguments, assisting negotiators in maintaining focus. Some examples may utilize NLP algorithms to identify recurring patterns in participants' speech, helping negotiators understand behavioral trends and adjust their approach. Some examples may present NLP-derived insights through visualizations, such as word clouds, sentiment graphs, or topic maps, enhancing negotiators' understanding of the negotiation dynamics. Some examples may display contextual tooltips or hints that guide users on the available functions or actions when they interact with different elements on the screen.

Some examples may be designed to operate effectively in diverse harsh environments by incorporating rugged construction, protective features, and specialized materials to ensure functionality and durability. Some examples may use high-strength, durable materials such as reinforced plastics, composite materials, or metal alloys to withstand impacts, vibrations, and harsh conditions. Some examples may implement a sealed and watertight construction to prevent water, dust, and debris ingress, safeguarding the internal components from environmental elements. Some examples may adhere to industry standards like IP (Ingress Protection) and MIL-STD (Military Standard) ratings that define their resistance to water, dust, impacts, and temperature variations. Some examples may use electronic components, batteries, and materials that can function within a temperature range of −50° F. to 140° F. without degradation. Some examples may allow for higher or lower temperatures than specified. Some examples may incorporate insulation to regulate internal temperatures and ventilation systems to prevent overheating in extreme heat. Some examples may also be designed to handle torrential rain by integrating specialized gaskets, O-rings, and waterproof seals to prevent water infiltration. Some examples may also apply hydrophobic coatings to surfaces to repel water and ensure it rolls off, minimizing water accumulation. In some examples, the cases may include built-in drainage channels to guide water away from sensitive components and prevent pooling. Some examples may use waterproof connectors and ports to ensure the integrity of the case's seal even when external cables are connected. Some examples may include desiccant packs or humidity control modules to absorb moisture and maintain optimal internal humidity levels. Some examples may also apply anti-corrosion coatings to metal components to prevent rust and deterioration in high humidity conditions. Some examples may apply chemical-resistant coatings to case surfaces or internal components to protect against exposure to corrosive substances. Some examples may utilize materials that can withstand changes in air pressure without compromising the case's structural integrity. Some examples may use lead-lined cases to shield internal components from radiation exposure. Some examples may also use materials that are less susceptible to radiation damage, such as certain polymers or ceramics.

Some examples may achieve user-friendly operation in the units of the system by designing intuitive interfaces and control methods that enhance ease of use, even in high-stress situations. Some examples may include user interfaces that are intuitive and resemble familiar technologies, minimizing the learning curve for negotiators. Some examples may use easily recognizable icons, symbols, and labels on screens to guide users through functions. Some examples may implement clear error messages and prompts that guide users back on track if they encounter issues. Some examples may integrate a high-quality touchscreen that responds accurately to touch inputs, ensuring smooth interaction. Some examples may incorporate common touch gestures like tapping, swiping, and pinching to control various functions. Some examples may integrate reliable voice recognition technology that accurately interprets spoken commands. In some examples, the system may understand natural language instructions, making voice control more intuitive. Some examples may incorporate sensors to detect gestures like hand movements, allowing users to control functions without physical contact. Some examples may provide visual or haptic feedback to confirm that actions, gestures, or button presses have been recognized and executed. Some examples may allow negotiators to create their own voice commands for specific functions, making voice control even more personalized. Some examples may leverage artificial intelligence (AI) to predict user actions and provide contextually relevant options in real time. Some examples may implement adaptive AI that learns from user preferences and behavior, customizing the interface over time. Some examples may incorporate adaptive user profiles that store individual preferences and settings, allowing negotiators to customize the interface according to their needs. Some examples may include dedicated physical buttons on the negotiator box for commonly used functions, ensuring immediate access without navigating through menus. Some examples may present complex options progressively, revealing advanced features only when the user expresses interest or when they become relevant to the ongoing negotiation. Some examples may include in-depth help sections or interactive tutorials that guide users through various features and controls.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1 and 3-11, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1 and 3-11, referred to above, need be included in every example and not all elements, features, and/or components described herein are necessarily depicted in each illustrative example. Accordingly, some of the elements, features, and/or components described and illustrated in FIGS. 1 and 3-11 may be combined in various ways without the need to include other features described and illustrated in FIGS. 1 and 3-11, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1 and 3-11, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1 and 3-11, and such elements, features, and/or components may not be discussed in detail herein with reference to each of FIGS. 1 and 3-11. Similarly, all elements, features, and/or components may not be labeled in each of FIGS. 1 and 3-11, but reference numerals associated therewith may be utilized herein for consistency.

In FIG. 2, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIG. 2 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the system 100 and the method 1000 have been shown and described, modifications may occur to those skilled in the art upon reading the specification. The present application includes such modifications and is limited only by the scope of the claims.

What is claimed is:

1. A system for emergency communications, the system comprising:
a host unit comprising a host access point; and
a command unit comprising a command access point,
wherein:
the host access point is configured to generate an area network; and
the host access point and the command access point establish a first peer-to-peer wireless connection over the area network.

2. The system of claim 1, further comprising a deployable unit comprising a deployable access point,
wherein the host access point and the deployable access point establish a second peer-to-peer wireless connection over the area network.

3. The system of claim 2, wherein:
the host access point has a host static IP address;
the command access point has a command static IP address;
the deployable access point has a deployable static IP address; and
the host static IP address, the command static IP address, and the deployable static IP address are different.

4. The system of claim 2, wherein:
the host access point comprises a host omnidirectional antenna for wireless communication with the command access point and the deployable access point;
the command access point comprises a command omnidirectional antenna for wireless communication with the host access point; and
the deployable access point comprises a plurality of deployable directional antennas for wireless communication with the host access point.

5. The system of claim 4, wherein:
the host omnidirectional antenna and the command omnidirectional antenna comprise a stick antenna; and
the plurality of deployable directional antennas comprises three sector antennas.

6. The system of claim 4, wherein the host access point further comprises a host directional antenna for wireless communication with the deployable access point.

7. The system of claim 2, wherein the host access point, the command access point, and the deployable access point wirelessly communicate with each other using a first frequency.

8. The system of claim 2, wherein the deployable unit further comprises at least one of a deployable broadcasting device, a deployable observing device, and a deployable communicating device in communication with the deployable access point.

9. The system of claim 8, wherein at least the one of the deployable broadcasting device, the deployable observing device, and the deployable communicating device is a network enabled device.

10. The system of claim 8, wherein at least the one of the deployable broadcasting device, the deployable observing device, and the deployable communicating device has a unique static IP address.

11. The system of claim 8, wherein at least the one of the deployable broadcasting device, the deployable observing device, and the deployable communicating device is remote from the deployable access point.

12. The system of claim 11, wherein the deployable communicating device comprises a mobile handset that communicates wirelessly with the deployable access point.

13. The system of claim 11, wherein:
the deployable access point comprises a deployable omnidirectional antenna for wireless communication with a remote one of the deployable broadcasting device, the deployable observing device, and the deployable communicating device; and
the deployable omnidirectional antenna is oriented at a 45-degree angle relative to orthogonal.

14. The system of claim 11, wherein:
the host access point, the command access point, and the deployable access point wirelessly communicate with each other using a first frequency;
the deployable access point and a remote one of the deployable broadcasting device, the deployable observing device, and the deployable communicating device wirelessly communicate with each other using a second frequency; and
the first frequency and the second frequency are different.

15. The system of claim 14, wherein the deployable access point further comprises a network bridge between the first frequency and the second frequency.

16. The system of claim 2, wherein the command unit further comprises a controlling device and a command communicating device in communication with the command access point.

17. The system of claim 2, wherein the host unit further comprises at least one of a host broadcasting device, a host observing device, and a host communicating device in communication with the host access point.

18. The system of claim 17, wherein at least the one of the host broadcasting device, the host observing device, and the host communicating device has a unique static IP address.

19. A system for emergency communications, the system comprising:
a host unit comprising:
a host access point configured to generate an area network; and
at least one of a speaker, microphone, and a camera in communication with the host access point;
a command unit comprising:
a command access point;
a controlling device in communication with the command access point; and
a headset in communication with the command access point; and
a deployable unit comprising:
a deployable access point; and
at least one of an intercom and a handset in communication with the deployable access point;
wherein:
the host access point and the command access point establish a first peer-to-peer wireless connection over the area network;
the host access point and the deployable access point establish a second peer-to-peer wireless connection over the area network; and
each one of the host access point, the command access point, and the deployable access point has a unique static IP address.

20. A method for emergency communications, the method comprising steps of:
generating an area network with a host access point;
establishing a first peer-to-peer wireless connection between the host access point and a command access point over the area network;
establishing a second peer-to-peer wireless connection between the host access point and a deployable access point over the area network;
wirelessly transmitting a data stream between the host access point and the command access point;
wirelessly transmitting the data stream between the host access point and the deployable access point; and
wirelessly transmitting the data stream between the command access point and the deployable access point via the host access point,
wherein a host static IP address, a command static IP address, and a deployable static IP address are different.
